(19) United States
(12) Patent Application Publication
(10) Pub. No.: US 2017/0350486 A1
(43) Pub. Date: Dec. 7, 2017

(54) POWER SHIFT TRANSMISSION FOR AN AGRICULTURAL MACHINE

(71) Applicant: ZF Friedrichshafen AG, Friedrichshafen (DE)

(72) Inventors: Gerhard BAILLY, Friedrichshafen (DE); Jürgen POHLENZ, Ravensburg (DE)

(21) Appl. No.: 15/498,932

(22) Filed: Apr. 27, 2017

(30) Foreign Application Priority Data
Jun. 7, 2016 (DE) 10 2016 209 942.6

(51) Int. Cl. F16H 37/04; F16H 3/08

(52) U.S. Cl. CPC F16H 37/043; F16H 3/08

(57) ABSTRACT

A powershift transmission for agricultural machines, which is of modular design and has a first part (1) with a splitter group (3) and a second part (2) with a multi-speed transmission (4). The splitter group (3) is designed such that the rotational direction of the input shaft (5) and the rotational direction of the output shaft (8) remain the same, even when shifts are carried out in the splitter group (3).

This application claims priority from German patent application serial no. 10 2016 209 942.6 filed Jun. 7, 2016.

### FIELD OF THE INVENTION

The invention concerns a powershift transmission for agricultural machines.

### BACKGROUND OF THE INVENTION

DE 10 2010 061 919 A1 discloses a powershift transmission for agricultural machines, with a splitter group designed for powershifting by means of friction clutches.

### SUMMARY OF THE INVENTION

The purpose of the present invention is to develop further powershift transmissions for agricultural machines having a powershiftable splitter group, in such manner that they can be constructed simply and inexpensively for the application for which they are intended,

This objective is achieved with a powershift transmission for agricultural machines, of the type concerned, which also embodies the characterizing features specified in the principal claim.

According to the invention, the powershift transmission for agricultural machines comprises a first transmission part in the form of a splitter group, which cooperates with a second transmission part in the form of a multi-speed transmission such that the second transmission part in the form of a multi-speed transmission has shiftable forward gears and at least one shiftable reversing gear, and the splitter group in the first transmission part is designed for powershifting and cooperates with the gearwheels and clutches in such manner that the rotational direction of the output shaft of the splitter group remains the same regardless of the gear ratio engaged in the splitter group. This makes it possible to connect to the output shaft of the splitter group, a standard multi-speed transmission, which can be designed in accordance with the driving speed and traction force needs to suit the agricultural machine concerned, for example a tractor.

In a further development of the invention it is possible to design the multi-speed transmission so that its shifts can be automated and/or are completely powershiftable. By designing the powershiftable splitter group and the multi-speed transmission as independent components of the powershift transmission, a modular assembly can be produced whose modules can be combined according to need.

### BRIEF DESCRIPTION OF THE DRAWINGS

Further characteristics emerge from the description of the figures, which show.

FIG. 1. A powershift transmission with a first part and a second part;

FIG. 2: A powershift transmission with a first part and a second part; and

FIG. 3: A powershift transmission with a first part and a second part.

### DETAILED DESCRIPTION OF THE PREFERRED EMBODIMENTS

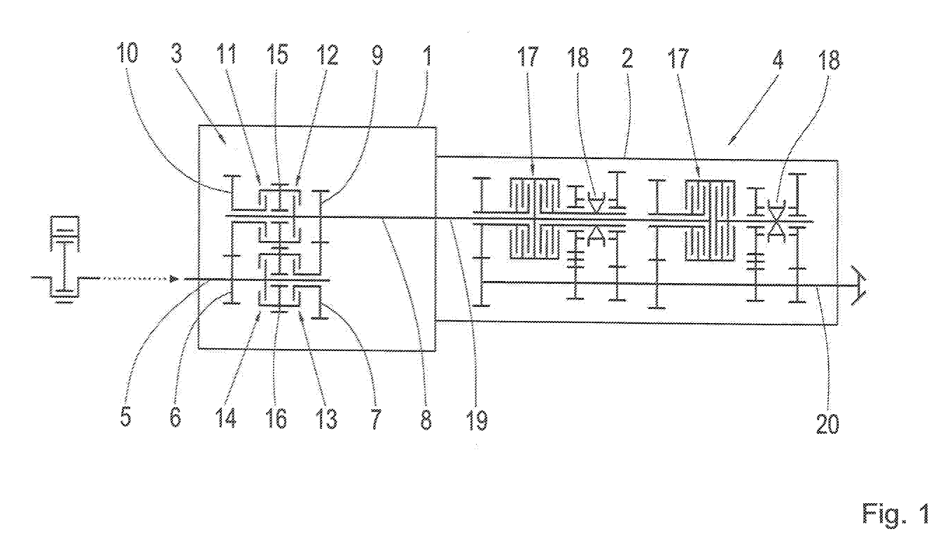

FIG. 1:

The powershift transmission consists of a first part 1 and a second part 2.

The first part 1 comprises a powershiftable splitter group 3 and the second part 2 comprises a multispeed transmission 4. The multispeed transmission 4 has a number of gears that can be engaged for forward driving and a number of gears that can be engaged for driving in reverse. The input shaft 5 of the splitter group 3 can be connected to a drive motor, for example an internal combustion engine. A spur gear 6 is connected coaxially and in a rotationally fixed manner to the input shaft 5. On the input shaft 5, a spur gear 7 is fitted and able to rotate. A spur gear 9 is connected coaxially and in a rotationally fixed manner to the output shaft 8. A spur gear 10 is fitted and able to rotate on the output shaft 8. By means of a clutch 11 the spur gear 10 can be connected to a spur gear 15. By means of a clutch 12 the output shaft can be connected to the spur gear 15. By means of a clutch 14 the spur gear 6 can be connected to a spur gear 16. By means of a clutch 13 the spur gear 7 can be connected to the spur gear 16. The spur gear 6 is in meshing connection with the spur gear 10. The spur gear 7 is in meshing connection with the spur gear 9 and the spur gear 15 is in meshing connection with the spur gear 16. By actuating the clutch 14 in the closing direction, actuating the clutch 13 in the opening direction and actuating the clutch 12 in the closing direction, the rotation of the input shaft 5 is transmitted to the output shaft 8. By actuating the clutches 13 and 14 in the closing direction and actuating the clutches 11 and 12 in the opening direction, a further gear is engaged. By actuating the clutch 14 in the opening direction, the clutch 11 in the closing direction, the clutch 13 in the closing direction and the clutch 12 in the opening direction, another gear is engaged. By actuating the clutches 11 and 12 in the closing direction and the clutches 13 and 14 in the opening direction a further gear is engaged. During the gearshifts the rotational direction of the input shaft 5 and the output shaft 8 remains unchanged. The multi-speed transmission 4 has friction clutches 17 and shifting elements 18, such that by means of the shifting elements 18 the various gear ratios are engaged. Since the rotational direction of the input shaft 5 and the output shaft 8 always remains the same, standard multi-speed transmissions can be connected to the output shaft 8. For that purpose the multi-speed transmission 4 has a drive input shaft 19, which is connected in a rotationally fixed manner to the output shaft 8 or is made integrally therewith. Furthermore, the multi-speed transmission 4 has a drive output shaft 20 which, for example, can be connected to a rear axle of a tractor.

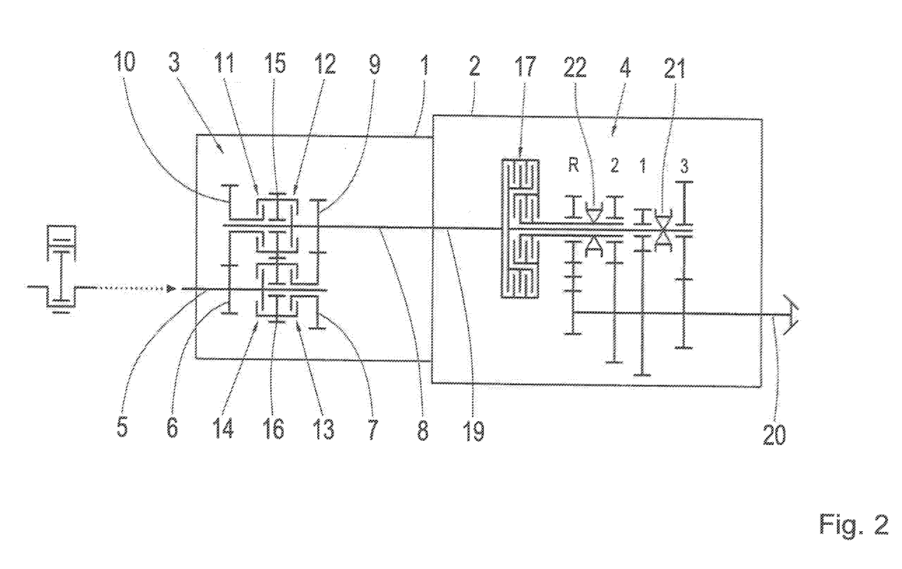

FIG. 2:

The first part of FIG. 2 is identical to the first part of FIG. 1. In the multi-speed transmission 4 shifts are made between various gear ratios by means of a shifting element 21 and the reversing gears are engaged by means of the shifting element 22. By virtue of the friction clutches 17 additional powershifts can be carried out.

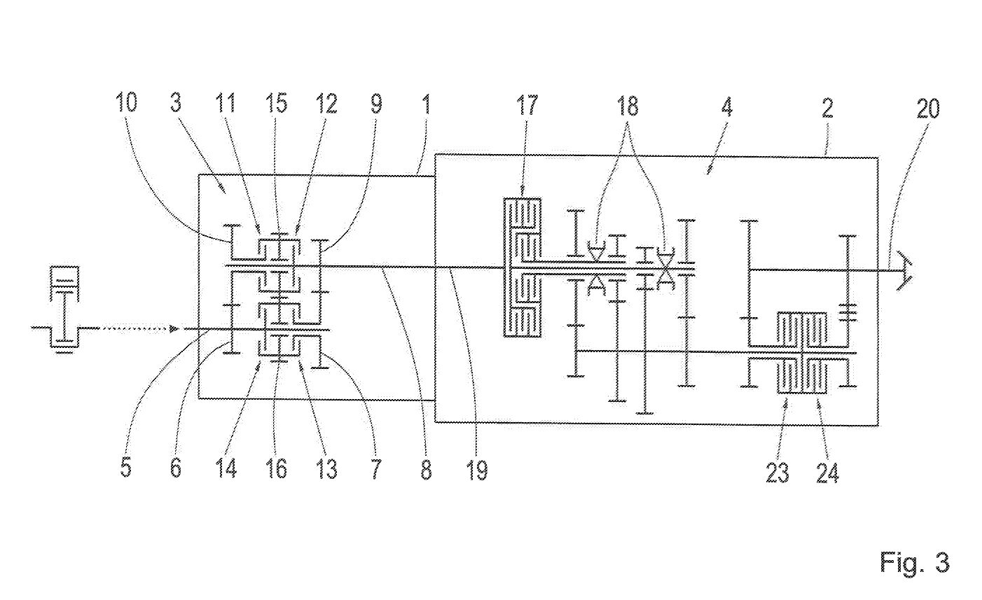

FIG. 3:

The first part of FIG. 3 is identical to the first part 1 of FIG. 1. The multi-speed transmission 4 has friction clutches 17 and shifting elements 18 by means of which various gear ratios can be engaged. These gear ratios can be engaged in the forward driving direction by means of the clutch 23 and in the reverse driving direction by means of the crutch 24.

### INDEXES

1 First part
2 Second part
3 Sputter group
4 Multispeed transmission
5 Input shaft
6 Spur gear
7 Spur gear
8 Output shaft
9 Spur gear
10 Spur gear
11 Clutch
12 Clutch
13 Clutch
14 Clutch
15 Spur gear
16 Spur gear
17 Friction clutch
18 Shifting element
19 Drive input shaft
20 Drive output shaft
21 Shifting element
22 Shifting element
23 Clutch
24 Clutch

1-9. (canceled)

10. A powershift transmission for agricultural machines, the powershift transmission comprising:
a first transmission part (1) in a form of a splitter group, and
a second transmission part (2) in a form of a multi-speed transmission,
the splitter group (3) having an input shaft (5) and an output shaft (8), and
the multi-speed transmission (4) having shiftable forward gears and at least one shiftable reversing gear,
the splitter group (3) comprising a spur gear transmission having six spur gears (6, 7, 9, 10, 15, 16) with three respective spur gears arranged coaxially with one another and by four clutches (11, 12, 13, 14), four different gear ratios being engagable, and
during shifting of the four clutches (11, 12, 13, 14), a rotational direction of the output shaft (8) of the splitter group (3) remains the same.

11. The powershift transmission according to claim 10, wherein the input shaft (5) of the splitter group (3) is connected in a rotationally fixed manner to a first spur gear (6) of the splitter group (3) and a first clutch (14) arranged coaxially with the first spur gear (6), and the output shaft (8) of the splitter group (3) is connected in a rotationally fixed manner to a second spur gear (9) of the splitter group (3) and a second clutch (12) arranged coaxially with the second spur gear (9), and a third spur gear (7) of the splitter group (3) is fitted and able to rotate on the input shaft (5) of the splitter group (3) and a third clutch (13) is connected in a rotationally fixed manner to the third spur gear (7), and a fourth spur gear (10) is fitted and able to rotate on the output shaft (8) of the splitter group (3) and a fourth clutch (11) is connected in a rotationally fixed manner to the fourth spur gear (10).

12. The powershift transmission according to claim 19, wherein the fourth spur gear (10) meshes with the first spur gear (6).

13. The powershift transmission according to claim 11, wherein the third spur gear (7) meshes with the second spur gear (9).

14. The powershift transmission according to claim 11, wherein a fifth spur gear (15) is arranged coaxially with the output shaft (8) and is connectable either by the second clutch (12) to the second spur gear (9) or by the fourth clutch (11) to the fourth spur gear (10).

15. The powershift transmission according to claim 11, wherein a sixth spur gear (16) is arranged coaxially with the input shaft (5) and is connectable in a rotationally fixed manner either by the first clutch (14) to the first spur gear (6) or by the third clutch (13) to the third spur gear (7).

16. The powershift transmission according to claim 10, wherein the output shaft (8) of the splitter group (3) is either connected in a rotationally fixed manner to a drive input shaft (19) of the multi-speed transmission (4) or is made integrally with the drive input shaft (19) of the multi-speed transmission (4).

17. The powershift transmission according to claim 10, wherein the multi-speed transmission (4) comprises at least one of friction clutches (17, 23, 24) and synchronizers (18, 21, 22) by which the different gears, in forward and reverse driving directions, are engagable.

18. The powershift transmission according to claim 10, wherein the multi-speed transmission (4) is a standard transmission.

19. A powershift transmission for agricultural machines, the powershift transmission comprising:
a splitter group having input and output shafts, first, second, third, fourth, fifth and sixth spur gears and first, second, third and fourth clutches;
the first, the third and the sixth spur gears are coaxially arranged with respect to one another on the input shaft, and the second, the fourth and the fifth spur gears are coaxially arranged with respect to one another on the output shaft;
the first, the second, the third and the fourth clutches are selectively engagable to facilitate engagement of four different gear ratios, and during shifting of the first, the second, the third and the fourth clutches, a rotational direction of the drive output shaft remains the same; and
a multi-speed transmission has a plurality of engagable forward gear ratios and at least one engagable reversing gear ratio.

20. The powershift transmission according to claim 19, wherein
the first spur gear is connected in a rotationally fixed manner to the input shaft, and the third and the sixth spur gears are loose spur gears that are rotatable with respect to the input shaft; and
the second spur gear is connected in a rotationally fixed manner to the output shaft, and the fourth and the fifth spur gears are loose spur gears that are rotatable with respect to the output shaft.

21. The powershift transmission according to claim 19, wherein
the first and the third clutches are arranged on the input shaft such that the first clutch is axially arranged between the first and the sixth spur gears and the third clutch is axially arranged between the sixth and the third spur gears; and
the second and the fourth clutches are arranged on the output shaft such that the second clutch is axially arranged between the second and the fifth spur gears and the fourth clutch is axially arranged between the fifth and the fourth spur gears.

22. The powershift transmission according to claim 19, wherein the first spur gear continually meshes with the fourth spur gear, the second spur gear continually meshes the third spur gear and the fifth spur gear continually meshes with the sixth spur gear.

23. The powershift transmission according to claim 22, wherein
engagement of the first and the second clutches and disengagement of the third clutch facilitates transmission of rotational drive from the input shaft to the output shaft;
engagement of the first and the third clutches and disengagement of the second and the fourth clutches facilitates engagement of one gear ratio;
engagement of the third and the fourth clutches and disengagement of the first and the second clutches facilitates engagement of another gear ratio; and
engagement of the second and the fourth clutches and disengagement of the first and the third clutches facilitates engagement of a further gear ratio.
